(19) United States
(12) Patent Application Publication
(10) Pub. No.: US 2008/0230623 A1
(43) Pub. Date: Sep. 25, 2008

(54) Portable remote control valve actuator apparatus

(76) Inventors: Donald H. Macnow, Glen Cove, NY (US); Scott D. Macnow, Glen Cove, NY (US)

Correspondence Address: Donald H. Macnow, 13 Hitching Post Lane, Glen Cove, NY, 11542, US

(21) Appl. No.: 12/001,175

(22) Filed: Dec. 10, 2007

Related U.S. Application Data
(60) Provisional application No. 60/919,278, filed on Mar. 22, 2007.

(51) Int. Cl. F16K 31/02; B05B 17/04; B05B 12/00; B05D 1/00

(52) U.S. Cl. 239/11; 251/129.04

(57) ABSTRACT

A remote control actuator apparatus comprising a recharger, a battery pack, a valve actuator, and connecting couplers. The valve actuator comprises an RF receiver and a 12 VDC/24VAC inverter. A hand held battery operated remote controller transmits a given signal for a given water valve control to an RF receiver in the valve actuator, which then sends 24 volts AC signal through a coupler to either a cable with magnetic connectors or a remote control module connected to wiring between the valve control and the valve.

### CROSS REFERENCES TO RELATED APPLICATIONS

Provisional Application for Patent No. 60/919,278 of Mar. 22, 2007 with the title “Portable Remote Control Valve Actuator With Magnetic Contacts” which is hereby incorporated by reference. Applicant claims priority pursuant to 35 U.S.C. Par. 119 (c).

Statement as to Rights to inventions made under Federally sponsored research and development: Not applicable

### BACKGROUND OF THE INVENTION

1. Field of the Invention

This invention relates to a radio controlled transmitter and receiver for operation of an irrigation systems electric solenoid valves from a remote location. Moreover, it pertains specifically to such an apparatus for temporarily bypassing an irrigation system's permanently hard-wired controller and to operate the system's electric valves from a location apart from said system's controller, using a satellite connector module connected to the system's solenoid valves and/or magnetic contacts that couple on to the valve terminals of the controller.

2. Background Information

Automatic controlled sprinkler systems comprising zones are used for commercial and residential lawn and turf care. These systems need to be maintained. When a service technician is required to operate a sprinkler system, such as in spring when the system is activated, or in the fall, when the system is winterized, the technician must turn on the controller, and sequentially activate each zone, one at a time. Generally, the controller is located in a building, such as in an owner's basement or garage. After each zone is activated, the technician must exit the house and inspect the operation of the particular zone. If a repair is necessary, the technician must then return to the controller, turn off the system, exit the building, accomplish the repair, and re-enter the building to turn on the zone so the technician operate the zone and then go out again to check the repair. Then, the technician must re-enter the building and go through this procedure with each of the subsequent zones in turn.

Sprinkler systems with 7 to 9 zones are not uncommon. This means a minimum of 8 to 10 entries and exits of an owner's home. Owners with such sprinkler systems tend to be security conscious, and are not enthused about the time consumed, as well as dirt, mud, and moisture tracked in and out of the home, too often left for the home owner to clean up.

A solution to alleviate the above procedure, is for the service company to dispatch two technicians, one to stay in the house operating the controls, and one to stay outside to inspect and repair as required. This increases expense, which does not enthuse the home owner either.

There are also security considerations for the home owner. Home owners, especially female home owners usually are not enthused about service technicians coming into the home.

Controller manufacturers have recognized the above problems and are offering controllers with an internal remote control system but they are not popular with home owners due to cost considerations. Also, there are many older controllers on the market, as well as in service, that do not have the capabilities of a remote control add on feature.

As will be seen from the subsequent description, the preferred embodiments of the present invention the present invention overcomes these and other problems with existing sprinkler system controls.

### SUMMARY OF THE INVENTION

The preferred embodiment of the present invention is a portable remote control valve actuator apparatus comprising a recharger, a battery pack, a valve actuator, and connecting couplers. The valve actuator comprises an RF receiver and a 12 VDC/24VAC inverter. A hand held battery operated remote controller transmits a given signal for a given water valve control to the RF receiver in the valve actuator, which transmits the signal through either a coupler with magnetic ends to the valve actuator or through a module coupler to a remote control module which is hard wired into the valve control wiring between the valve control and the water valves to be controlled.

If there is no remote control module, the connector with magnetic ends is used to preclude the necessity of making less convenient electrical wiring connections.

### BRIEF DESCRIPTION OF THE DRAWINGS

FIG. 1 illustrates the preferred embodiment of the present invention, a portable remote control valve actuator apparatus.

FIG. 2 is an electrical schematic of an inverter/receiver assembly.

FIG. 3 illustrates an irrigation system control with a magnetic coupler.

FIG. 4 illustrates a satellite module with connector.

### DESCRIPTION OF THE PREFERRED EMBODIMENTS

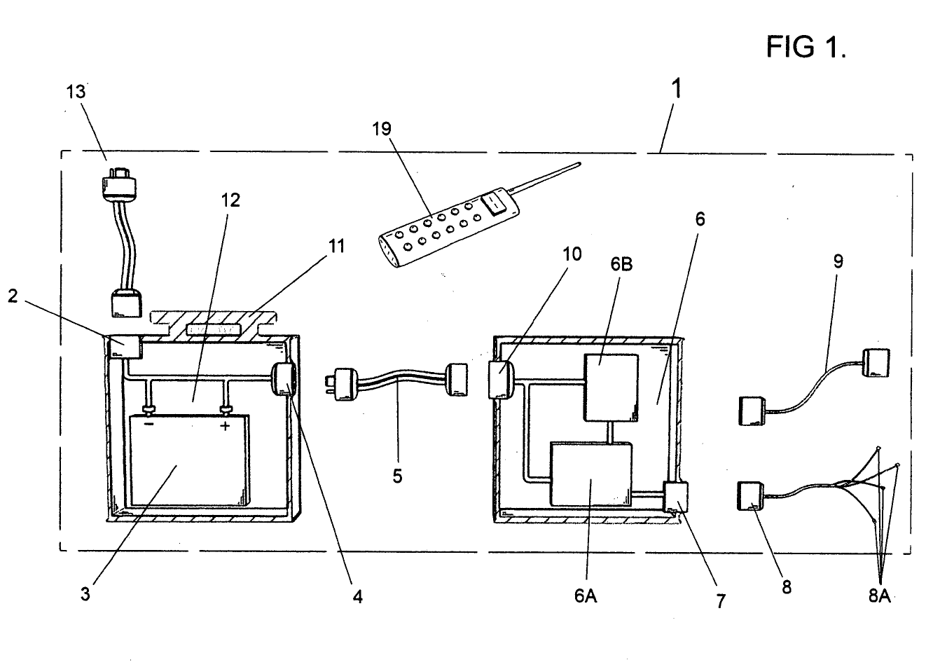

FIG. 1 illustrates the preferred embodiment of the present invention, a portable remote control valve actuator apparatus 1 comprising a prior art recharger 13, a prior art 12 VDC battery pack 12, a battery pack/valve actuator connector 5, a valve actuator 6, a valve actuator/irrigation valve control coupler 8 with magnetic ends 8A, a valve actuator/irrigation valve satellite module coupler 9, and RF transmitter 19 which is a prior art commercially available hand held battery operated remote control, common to the electrical and electronics trades.

The prior art recharger 13 is a common recharger such as is used for cell phones or similar devices that plug into a 110 VAC outlet and into a 12 VDC unit.

The prior art battery pack 12 comprises a battery pack inlet 2, a 12 VDC battery 3, a battery pack outlet 4, and a handle 11.

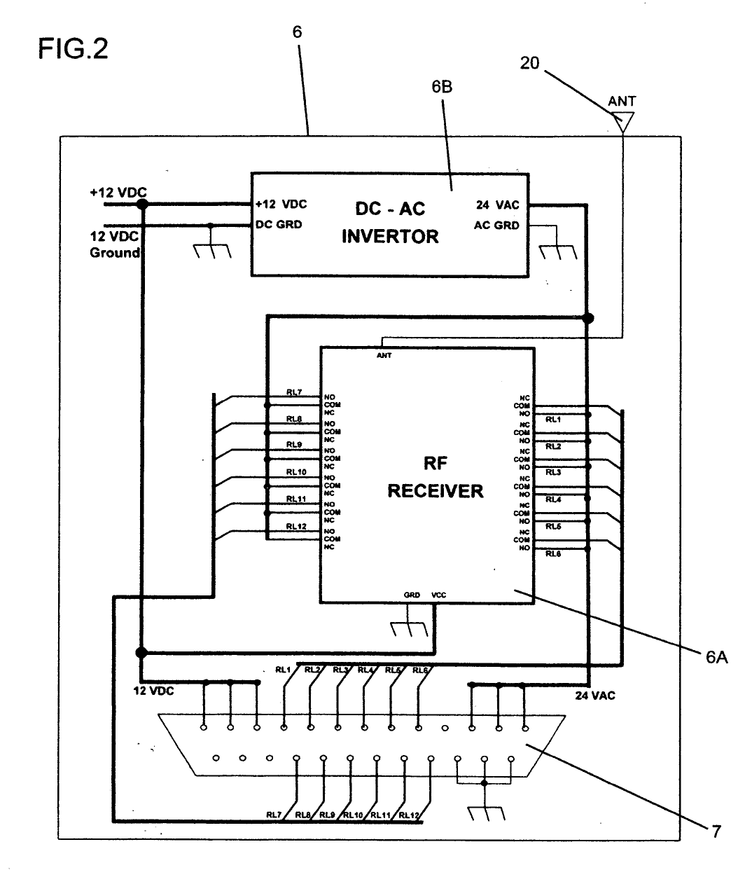

Referring also to FIG. 2 which is an electrical schematic, the valve actuator 6 comprises 12 VDC/24 VAC inverter 6B and a 12 VDC RF receiver 6A as well as the actuator 12 VDC receptacle 10 and the actuator 24 VAC connector pin outlet 7 shown in FIG. 1. The valve actuator 6 includes an antenna 20 to receive a signal from the transmitter 19. That signal indicates a number associated with a valve 16 to be activated. The logic control in the RF receiver 6A converts the signal received by the antenna 20. Once the RF receiver 6A receives a signal from the transmitter 19 it closes a relay corresponding to the numbered button of the transmitter 19. The activated relay routes a 24VAC current from the DC/AC inverter 6B to the corresponding connector pin outlet 7 and on to the corresponding valve 16 through either the magnetic connector cable 8 or the satellite assembly cable 9.

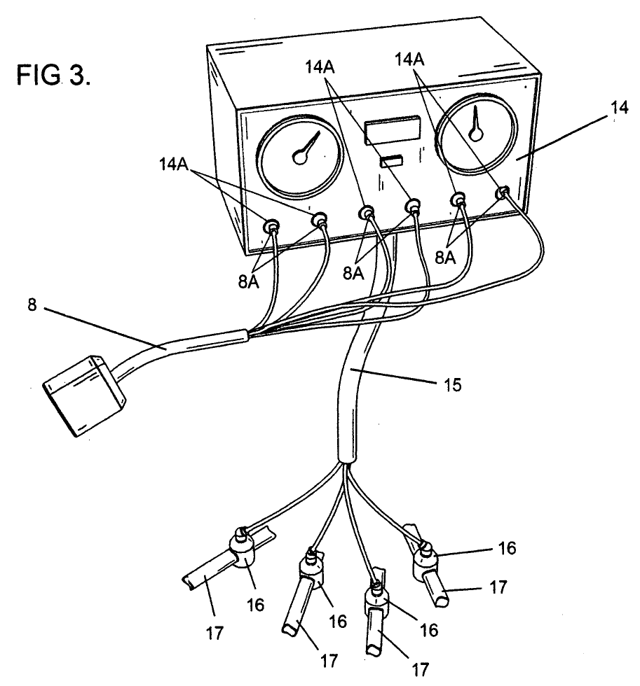

Referring to FIG. 3, FIG. 3 shows an existing irrigation valve control 14, which can be a programmable controller that allows a user to program times when watering should occur and to control which among several areas might get watered. The existing irrigation system also includes electrical wiring 15, multiple electric operated water control valves 16 with water lines 17. Typically, each of said valves 16 controls water flow to an area of ground to be irrigated (not shown). Shown with the valve control 14, is the magnetic connector cable 8 with the magnetic coupler ends 8A attached to test connections such as the wiring screws 14A common to valve controls such as said valve control 14.

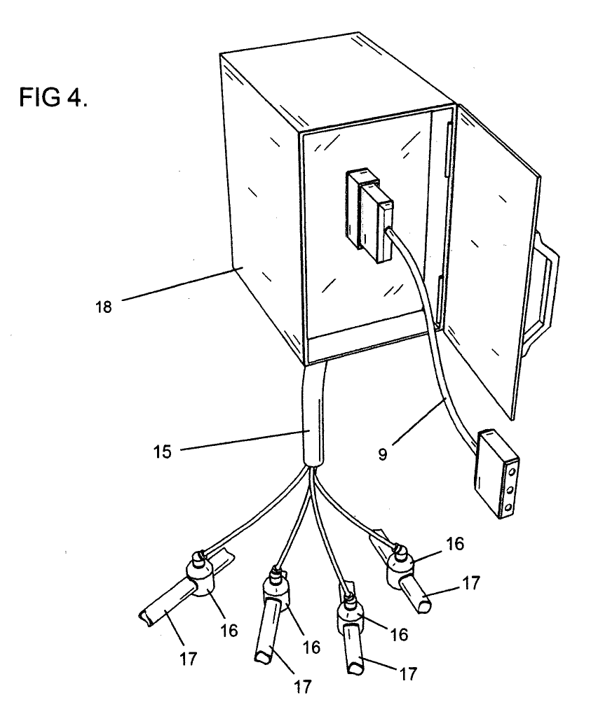

Referring to FIG. 4, in some irrigation systems, said valve control 14 may be in a building with a controlled access, and a remote control module 18 is connected to the wiring 15 between said valve control 14 (not shown in FIG. 4) and said valves 16 with water lines 17. In such cases, said coupler 9 connects the valve actuator 6 to the remote control module 18 to actuate said valves 16.

In operation, a service technician needing to service a lawn watering system with a controller 14 accessible will first connect magnetic cable ends 8A of cable 8 onto test wiring screws 14A, or if a satellite module 18 (FIG. 4) has been previously installed the technician may elect to connect the cable 9 (FIG. 4) into the remote control module 18 and thus bypass the programmable controller 14. The system 1 can either be plugged in if power is available or run from battery 3 in portable power pack 12. The technician can then key in a valve number and that valve will be activated. This allows the service technician freedom to move around and inspect the operation of each part of the irrigation equipment.

Although the description above contains many specificities, these should not be construed as limiting the scope of the invention, but as merely providing illustrations of some of the presently preferred embodiments of this invention.

It will be obvious to those skilled in the art that modifications may be made to the embodiments described above without departing from the scope of the present invention. Thus the scope of the invention should be determined by the appended claims in the formal application and their legal equivalents, rather than by the examples given.

I claim:

1. A control system for remotely operating a controller for a plurality of water valves, said control system comprising:
a) a portable RF transmitter
b) a portable RF receiver
wherein said RF transmitter includes keys for sending a signal;
wherein the RF receiver includes a portable battery power source and an antenna for receiving said signal from said RF transmitter;
wherein said RF receiver includes a cable to connect said receiver to said controller to open a valve corresponding to a number keyed into said keys on said transmitter.

2. The control system of claim 1 wherein said cable includes magnetic coupler ends to connect said cable to test connections on said controller.

3. The control system of claim 1 wherein said cable includes an end to connect to a satellite module.

4. The control system of claim 1 wherein said battery power source is a 12 volt source and said RF receiver includes an inverter to convert 12 volt power to 24 volt power.

5. A control system for remotely operating a plurality of water valves, said control system comprising:
a) a portable transmitter
b) a portable receiver
wherein said transmitter includes keys for sending a signal;
wherein the receiver includes a portable battery power source and an antenna for receiving said signal from said transmitter;
wherein said receiver includes a cable to connect said receiver to a valve operator to open a valve corresponding to a number keyed into said keys on said transmitter.

6. The control system of claim 5 wherein said transmitter and said receiver use RF signals.

7. The control system of claim 6 wherein said operator includes a programmable controller having test connection points and said receiver includes a cable to connect said receiver to said controller.

8. The control system of claim 7 wherein said cable includes magnetic coupler ends to connect said cable to test connections on said controller.

9. The control system of claim 7 wherein said system includes a handle.

10. The control system of claim 7 wherein said battery power source is a 12 volt source and said RF receiver includes an inverter to convert 12 volt power to 24 volt power.

11. A control system for remotely operating a plurality of water valves, said control system comprising:
a) a portable RF transmitter
b) a portable RF receiver
wherein said transmitter transmits a signal containing information about which valve to operate;
wherein the receiver includes an antenna for receiving said signal from said transmitter; wherein said receiver includes a cable to connect said receiver to a valve operator to open a valve corresponding to a number indicated by said transmitter.

12. The control system of claim 11 wherein said operator includes a programmable controller having test connection points and said receiver includes a cable to connect said receiver to said controller.

13. The control system of claim 12 wherein said cable includes magnetic coupler ends to connect said cable to test connections on said controller.

14. The control system of claim 11 wherein said valve operator is a remote control connected to said controller and connecting said cable to said remote control bypasses said controller.

15. A method of controlling a water sprinkler system including the steps of; programming a controller to water an area at certain times, overriding said controller by providing a valve actuation signal, wherein said step of overriding includes the steps of providing an RF signal containing a signal to designate a specific valve from a plurality of possible valves, receiving said RF signal and supplying said signal to test contacts on said controller to override the control of said controller and actuate said valve.

16. The method of claim 15 wherein the step supplying said signal to test contact includes the step of magnetically connecting a cable from an outlet of said receiver to one of the test contacts of said controller.
